(19) United States
(12) Patent Application Publication
(10) Pub. No.: US 2011/0179355 A1
(43) Pub. Date: Jul. 21, 2011

(54) VIRTUAL INFORMATION INPUT ARRANGEMENT

(75) Inventor: David Karlsson, Lund (SE)

(73) Assignee: SONY ERICSSON MOBILE COMMUNICATIONS AB, Lund (SE)

(21) Appl. No.: 12/687,941

(22) Filed: Jan. 15, 2010

(51) Int. Cl. G06F 3/041; G06F 3/048

(52) U.S. Cl. 715/702; 345/173; 715/773

(57) ABSTRACT

An enhanced display device may include a touch screen having a display surface configured to display images, the touch screen being configured to output a signal indicative of where on the display surface the touch screen is touched. The display device may also include a controller configured to generate a virtual keyboard image including a number of virtual keys for display on the display surface, and at least one arrangement configured to receive a variable, wherein the controller is configured to generate the virtual keyboard image with at least one varying touch area based on the received variable.

### TECHNICAL FIELD

The present invention relates to an enhanced virtual information input in general, and virtual keyboards in particular.

### BACKGROUND

Various devices that use touch screens as graphical user interfaces are known. For instance, mobile telephone devices, personal organizer devices and the like are able to display virtual keys, including alpha-numeric keys and icons, on the display surface of the touch screen and respond to the display surface being touched by a user to carry out appropriate functions identified by the keys displayed on the display surface.

Text input speed on mobile devices with virtual keyboards are limited by the screen size, since the keys cannot have same size as on, for example, a keyboard for a personal computer. Thus, there are many schemes for increasing the text input speed, most notably predictive input where the device suggests words based on the current input, and gives the user a choice among a set of words as an alternative to typing entire words.

The problem with such a solution is that if one is able to input text reasonably fast, it will probably slow down the input speed instead of making it faster, since one has to change focus from the keys to the suggested words, and then move fingers/stylus to the suggested words from the virtual keyboard (and back). If one exaggerates, it may be like writing an email on a PC and having to move the fingers from the keyboard to touch the PC display to complete words, and for the fast typist, such a solution will be inherently slower.

Another problem with predictive input is that it is more complex solution for the user, the word completion paradigm is very familiar to, e.g., all UNIX users, but many less tech savvy users will not want to use predictive input, and will just become confused.

Additional problems may arise depending on the ambient light or if the user types while moving.

### SUMMARY

Aspects described herein address at least some of the above mentioned problems and provide for enhanced character input in mobile devices using virtual keyboards.

In an exemplary implementation, a display device is provided comprising: a touch screen having a display surface configured to display images, the touch screen being configured to output a signal indicative of where on the display surface the touch screen is touched; a controller configured to generate a virtual keyboard image including a plurality of virtual keys for display on the display surface; and at least one arrangement configured to receive a variable. The controller is configured to generate the virtual keyboard image with at least one varying touch area based on the received variable. According to one embodiment, the variable is one or several of an input frequency of virtual key strokes of a user, motion or ambient light strength. In one embodiment, the controller is configured to choose, as the display portion increased sensitivity for remaining areas. The virtual keyboard may be an image including a standard alphabet key array. The display device may further comprise a predictive text engine, configured to, based on a touch on the display surface corresponding to a virtual key, generate a signal to said controller to generate said virtual keyboard image with varying touch area. In one embodiment, the controller is configured to be in a first and a second mode, wherein in said first mode the touch area is not varied and in said second mode, said touch area is varied with respect to said received variable. The display device may further comprise a predictive text engine and a key input frequency counter configured to, based on input frequency and a predicted text by said predictive text engine, generate a signal to said controller to generate said virtual keyboard image with varying touch area.

Aspects of the invention also relate to a portable telephone device comprising a display device comprising: a touch screen having a display surface configured to display images, the touch screen being configured to output a signal indicative of where on the display surface the touch screen is touched; a controller configured to generate a virtual keyboard image including a plurality of virtual keys for display on the display surface; and at least one arrangement configured to receive a variable. The controller is configured to generate the virtual keyboard image with at least one varying touch area based on the received variable. The telephone device may further comprise one or several of an input frequency counter of virtual key strokes, motion sensor or ambient light strength sensor. The virtual keyboard is an image including a standard alphabet key array. The device may further comprise a predictive text engine configured to, based on a touch on the display surface corresponding to a virtual key, generate a signal to said controller to generate said virtual keyboard image with varying touch area. In one embodiment, the controller is configured to be in a first and a second mode, wherein in said first mode the touch area is not varied and in said second mode, said touch area is varied with respect to said received variable.

Aspects of the invention also relate to a portable electric device including a display device comprising: a touch screen having a display surface configured to display images, the touch screen being configured to output a signal indicative of where on the display surface the touch screen is touched; a controller configured to generate a virtual keyboard image including a plurality of virtual keys for display on the display surface; and at least one arrangement configured to receive a variable. The controller is configured to generate the virtual keyboard image with at least one varying touch area based on the received variable.

Aspects of the invention also relate to a method of displaying a virtual keyboard image on the display surface of a touch screen configured to output a signal indicative of where on the display surface the touch screen is touched. The method comprises: sensing one variable effecting user character input, responsive to the sensed variable increasing predetermined screen areas relevant to a specific information displayed.

Aspects of the invention also relate to a computer program code comprising program code means for performing displaying a virtual keyboard image on the display surface of a touch screen configured to output a signal indicative of where on the display surface the touch screen is touched. The computer code comprises: a code set for sensing one variable effecting user character input, a code set responsive to the sensed variable for increasing predetermined screen areas relevant to specific information displayed.

Aspects of the invention also relate to a computer product comprising program code means stored on a computer readable medium for performing displaying a virtual keyboard image on the display surface of a touch screen configured to output a signal indicative of where on the display surface the touch screen is touched. The computer code comprises: a code set for sensing one variable effecting user character input, and a code set responsive to the sensed variable for increasing predetermined screen areas relevant to specific information displayed.

### BRIEF DESCRIPTION OF THE DRAWINGS

The invention will be more clearly understood from the following description, given by way of example only, with reference to the accompanying drawings, in which:

FIG. 1 illustrates schematically a mobile telephone device in which the present invention may be embodied;

FIG. 2 illustrates schematically a display device embodying the present invention;

FIG. 3 illustrates schematically the touch screen and control components of the display device of FIG. 2;

FIG. 4 is an exemplary state machine for the text input engine;

FIGS. 5a to 5c illustrate examples of a virtual keyboard; and

FIG. 6 illustrates a block diagram of a controller according to the invention.

### DETAILED DESCRIPTION

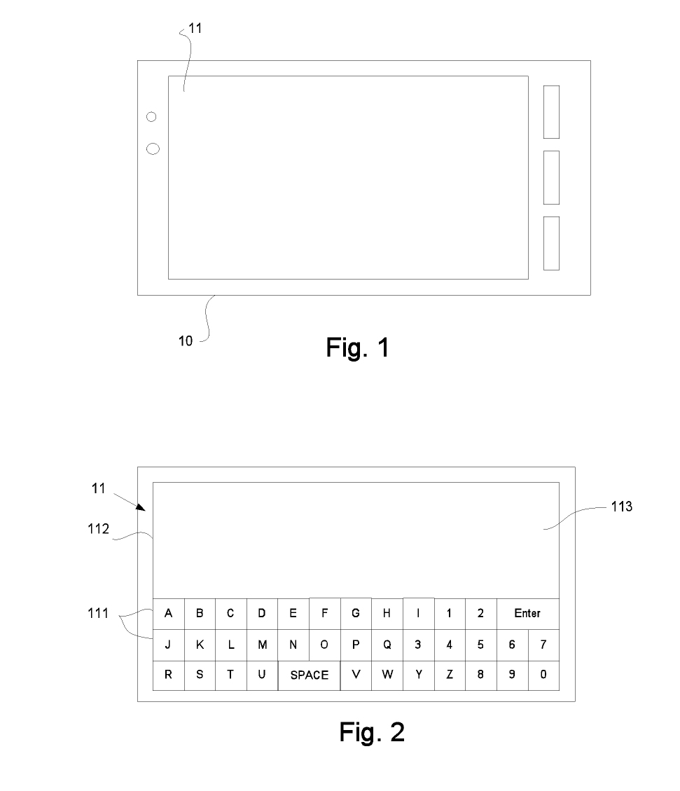

The present invention can be embodied in a wide variety of devices using a touch screen as a graphical user interface, such as mobile phones, personal digital organizers, gaming devices, navigation devices, etc. In this regard, the invention is described with reference to a mobile phone 10 illustrated schematically in FIG. 1, incorporating a display device 11 according to the present invention.

As will be described in greater detail below, the display device 11 of FIG. 2 includes a touch screen on which a plurality of keys 111 may be displayed. The touch screen is sensitive to touch by a user and, in response to such touch, outputs a signal such that touching the display surface of the touch screen at a position corresponding to a displayed key causes operation of a function corresponding to that displayed key.

The display device 11 illustrated in FIG. 2 includes a touch screen 112 with a display surface 113.

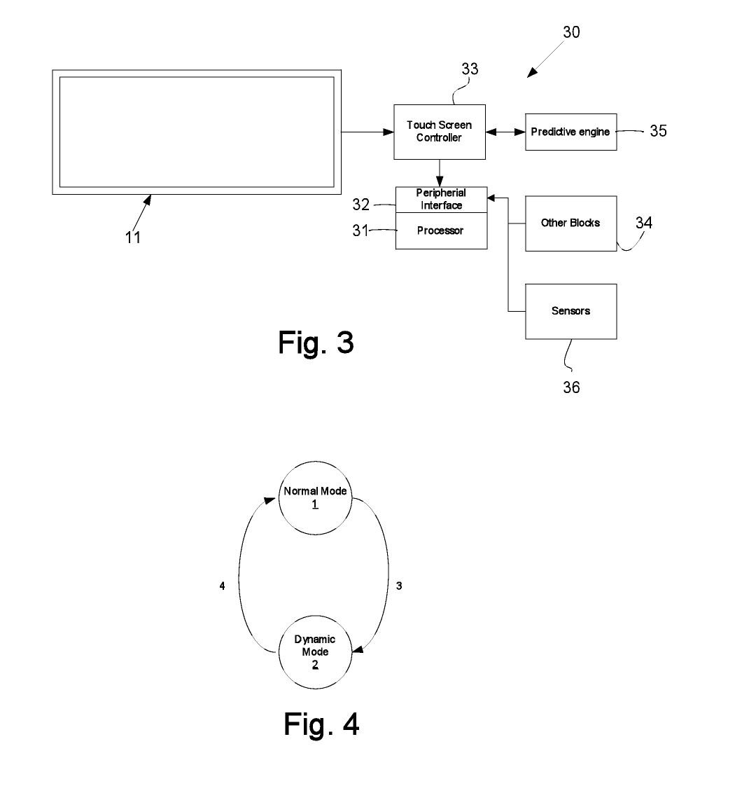

FIG. 3 illustrates schematically the display device together with its various control features comprising its controller 30.

As illustrated, a main processor 31 is provided with a peripheral interface 32. By means of the peripheral interface 32, the main processor 31 communicates with a touch screen controller 33, sensors 36 and other functional blocks 34, such as a universal serial bus (USB) controller or interfaces for other input/output. The main processor 31 further communicates with a predictive engine 35. The predictive engine, which may be implemented as a software routine, predicts the possible words which may be generated based on the entered characters. The predictive text input may be the well-known T9 solution. In a predictive text input solution, only one key input actuation per button is required based on which a number of proposed words are determined. The proposed words are presented to the user, e.g., in a list and among these proposed words, the user chooses the one he/she had in mind.

The sensors 36 may comprise one or more of an accelerometer, an ambient light sensor, etc. The accelerometer detects the movement of the device. An ambient light sensor, which may be a part of camera (not shown) of the device, detects the ambient light strength.

By means of the touch screen controller 33, it is possible to drive the touch screen to display images on the display surface 113. Also, the position at which the touch screen is touched by a user can be communicated with a processor 31 so as to enable appropriate functions to be controlled.

The appropriately configured controller 30, including processor 31, is arranged to generate a virtual keyboard image including a plurality of virtual keys 111 which can be displayed on the display surface 113 of the touch screen 11.

In an embodiment, the virtual keyboard image is an image of a standard alphabetic keyboard, such as a “QWERTY” keyboard. In the illustrated embodiment of FIG. 2, common keys, such as shift, arrow keys, etc., are not illustrated.

The controller 30 is configured to be able to drive the touch screen to display only a portion of the total virtual keyboard on the display surface at any one time.

In one embodiment, the controller 30 may be configured to generate the virtual keyboard in several portions in several screens.

According to aspects of the present invention, the controller 30 is configured to handle touch text input in such a fashion that it measures text input speed on the virtual keyboard and when the input speed is above a certain threshold, it changes the sizes of the letter hit zones so that more probable letters will have a larger hit zones (based on analysis of the text), without changing any visual elements or the visual size of the keys, which may distract or confuse the user.

According to a first aspect of the invention, the idea is that when the user is typing slowly there is no point in changing the hit zones because the user will have high precision, and if there is a mismatch between the hit zone of a key and the visual appearance of the key, it may be detected easily.

However, if the text input speed (or frequency) is reasonably high, which will make the probability of an incorrect key press higher, the problem may be reduced by changing the hit zone size of the letters to a different size than that of the visual key element.

Also, if the input speed is reasonably high, the user will not notice that the hit zones have changed, and if that causes the user to press the wrong key, then the user will decrease input frequency and/or delete the incorrect key, in which case he will enter the normal mode of input, where the hit zones correspond to the visual keys.

According to a second aspect of the invention, the motion of the device may be detected by the accelerometer, which means that the user is moving and due to the movement, the user may not be able to focus and if the detected movement is above a certain threshold, the keyboard changes the sizes of the letter hit zones so that more probable letters will have larger hit zones (based on analysis of the text), without changing any visual elements or the visual size of the keys, which may distract or confuse the user.

According to a third aspect of the invention, the ambient light conditions of the device may be detected by the light sensor, which means that if the user is using the device with low ambient light and the user may have difficulty seeing and focusing, and if the detected light strength is below a certain threshold, the keyboard changes the sizes of the letter hit zones so that more probable letters will have a larger hit zones (based on analysis of the text), without changing any visual elements or the visual size of the keys, which may distract or confuse the user. Also the illumination intensity of the display may be increased.

According to a fourth aspect of the invention, a combination of two or all of the above mentioned conditions may be used.

In FIG. 4, an exemplary state machine for the text input engine is illustrated. In this example the device has two modes: normal mode 1 and dynamic hit zone mode 2.

The transition depends on one or more of:

1) The input speed or frequency (f). Hence, a transition 3 from normal mode to the dynamic hit zone mode is executed if fᵢₙₚᵤₜ>fᵢₙₚᵤₜ_{_{—}}_{threshold} and a transition 4 from the dynamic hit zone mode 2 to the normal mode 1 is obtained if fᵢₙₚᵤₜ<fᵢₙₚᵤₜ_{_{—}}_{threshold} or if a character is deleted or input aborted. fᵢₙₚᵤₜ represents character input speed or frequency and fᵢₙₚᵤₜ_{_{—}}_{threshold} represents threshold value for the input speed or frequency.

2) Movement of the device: a transition 3 from normal mode to the dynamic hit zone mode is executed if a_{device} >a_{device}_{_{—}}_{threshold} and a transition 4 from the dynamic hit zone mode 2 to the normal mode 1 is obtained if a_{device} <a_{device}_{_{—}}_{threshold} or input aborted. a_{device} represents device acceleration and a_{device}_{_{—}}_{threshold} represents threshold value for the acceleration of the device (e.g., device 10).

3) Ambient luminance: a transition 3 from normal mode to the dynamic hit zone mode is executed if l_{ambient} >l_{ambient}_{_{—}}_{threshold} and a transition 4 from the dynamic hit zone mode 2 to the normal mode 1 is obtained if l_{ambient} <l_{ambient}_{_{—}}_{threshold} or input aborted. l_{ambient} represents device ambient light strength and l_{ambient}_{_{—}}_{threshold} represents threshold value for the ambient light of the device.

In another embodiment, the device may only have a dynamic hit zone mode or the mode may be set manually by the user.

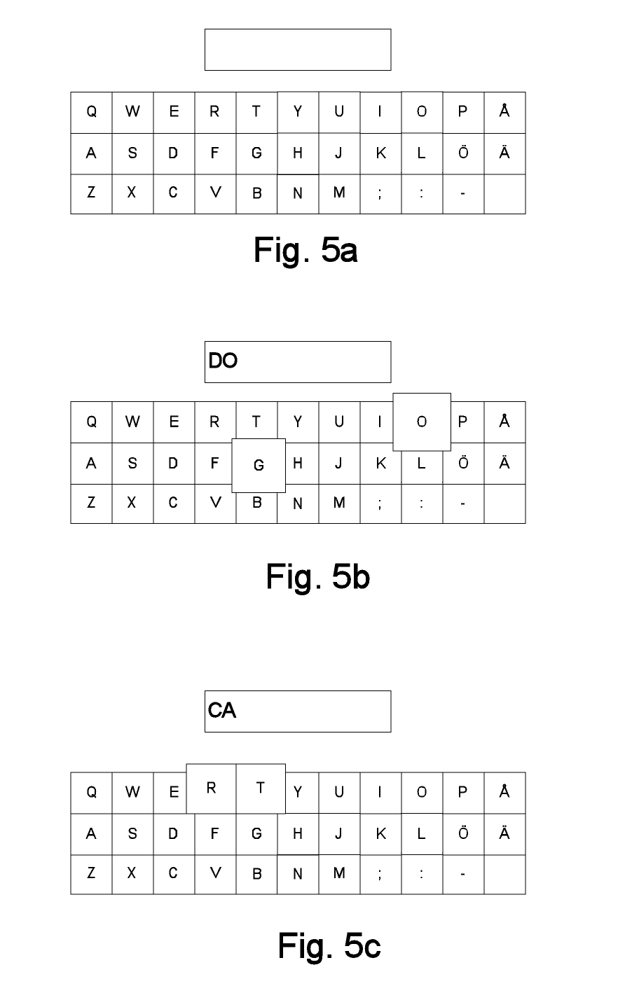

FIGS. 5a-5c show a virtual keyboard, with a QWERTY layout, in accordance with aspects of the present invention. In FIG. 5a, hit zones are the same for all keys, and they correspond to the visual key elements. The box above the keyboard corresponds to the display that will show the entered characters.

In FIG. 5b, the user has entered the letters “DO” and the predictive engine predicts that DOOR or DOG may be a probable continuation. In this example, assume that the frequency of input fᵢₙₚᵤₜ is >fᵢₙₚᵤₜ_{_{—}}_{threshold} and/or acceleration of the device >a_{device}_{_{—}}_{threshold} and/or the ambient light strength >l_{ambient}_{_{—}}_{threshold}. As a result, the engine is in dynamic mode and it increases the hit zone for the letters G and O, and decreases the hit zone for all the keys neighboring G and O. In one embodiment, this may be visible for the user, such as larger displayed key areas for the G and O, but normally this may not be visible to the user. In other words, the visible sizes of the G and O may not change. The hit zone in this context refers to the sensing area of the touch screen.

In FIG. 5c, the user has entered the letters “CA” and the predictive engine predicts that CAR or CAT is a probable continuation. In this example, assume that the frequency of input is >fᵢₙₚᵤₜ_{_{—}}_{threshold} and/or acceleration of the device >a_{device}_{_{—}}_{threshold} and/or the ambient light strength >l_{ambient}_{_{—}}_{threshold}. As a result, the engine is in dynamic mode and it increases the hit zone for the letters R and T, and decreases the hit zones for all keys neighboring R and T. But since these keys are next to each other, their respective hit zones cannot be increased towards each other, and are slightly limited as compared to the example in FIG. 5b.

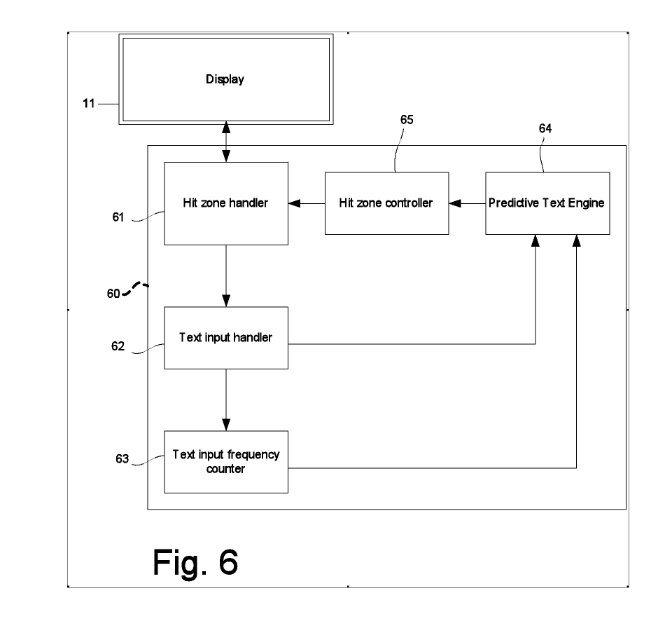

FIG. 6 is a block diagram of an exemplary controller 60 illustrating the relationship between the different parts of the implementation of the present invention. The controller 60 communicates with the touch screen display 11 and receives data from the virtual keyboard. The controller comprises a hit zone handler 61, which receives data from the areas corresponding to a key of the virtual keyboard. The data from the key strokes are converted to text in the text input handler 62, which provides text to the predictive text engine 64 and text input frequency counter 63, which determines the speed or frequency of the character input by the user and based on the frequency, the mode for hit zone handling is determined. The predictive text engine 64 predicts the text and outputs the relevant keys assumed to be stroked to the hit zone controller 65, which controls the hit zone handler for increasing/decreasing hit zones based on the text predicted.

The various embodiments of the present invention described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A display device comprising:
a touch screen having a display surface configured to display images, the touch screen being configured to output a signal indicative of where on the display surface the touch screen is touched;
a controller configured to generate a virtual keyboard image including a plurality of virtual keys for display on the display surface; and
at least one arrangement configured to receive a variable; wherein
the controller is configured to generate the virtual keyboard image with at least one varying touch area based on the received variable.

2. A display device according to claim 1, wherein said variable is at least one of an input frequency of virtual key strokes of a user, motion or ambient light strength.

3. A display device according to claim 1, wherein said controller is configured to choose, as the display portion, increased sensitivity for remaining areas.

4. A display device according to claim 1, wherein the virtual keyboard is an image including a standard alphabet key array.

5. A display device according to claim 1, further comprising a predictive text engine, configured to, based on a touch on the display surface corresponding to a virtual key, generate a signal to said controller to generate said virtual keyboard image with varying touch area.

6. A display device according to claim 1, wherein said controller is configured to be in a first or a second mode, wherein in said first mode the touch area is not varied and in said second mode, said touch area is varied with respect to said received variable.

7. A display device according to claim 1, further comprising a predictive text engine and a key input frequency counter, configured to, based on input frequency and a predicted text by said predictive text engine, generate a signal to said controller to generate said virtual keyboard image with varying touch area.

8. A portable telephone device comprising a display device comprising:
a touch screen having a display surface configured to display images, the touch screen being configured to output a signal indicative of where on the display surface the touch screen is touched;
a controller configured to generate a virtual keyboard image including a plurality of virtual keys for display on the display surface; and
at least one arrangement for configured to receive a variable; wherein
the controller is configured to generate the virtual keyboard image with at least one varying touch area based on the received variable.

9. A device according to claim 8, further comprising at least one of an input frequency counter of virtual key strokes, motion sensor or ambient light strength sensor.

10. A device according to claim 8 wherein the virtual keyboard is an image including a standard alphabet key array.

11. A device according to claim 8, further comprising a predictive text engine, configured to, based on a touch on the display surface corresponding to a virtual key, generate a signal to said controller to generate said virtual keyboard image with varying touch area.

12. A device according to claim 8, wherein said controller is configured to be in a first or a second mode, wherein in said first mode the touch area is not varied and in said second mode, said touch area is varied with respect to said received variable.

13. A portable electric device including a display device comprising:
a touch screen having a display surface configured to display images, the touch screen being configured to output a signal indicative of where on the display surface the touch screen is touched;
a controller configured to generate a virtual keyboard image including a plurality of virtual keys for display on the display surface; and
at least one arrangement for configured to receive a variable; wherein
the controller is configured to generate the virtual keyboard image with at least one varying touch area based on the received variable.

14. A method of displaying a virtual keyboard image on the display surface of a touch screen configured to output a signal indicative of where on the display surface the touch screen is touched, the method comprising:
sensing one variable effecting user character input, and
responsive to the sensed variable, increasing predetermined screen areas relevant to a specific information displayed.

15. A computer program code comprising program code means for performing displaying a virtual keyboard image on the display surface of a touch screen configured to output a signal indicative of where on the display surface the touch screen is touched, the computer code comprising:
a code set for sensing one variable effecting user character input, and
a code set responsive to the sensed variable for increasing predetermined screen areas relevant to a specific information displayed.

16. A computer product comprising program code means stored on a computer readable medium for performing displaying a virtual keyboard image on the display surface of a touch screen configured to output a signal indicative of where on the display surface the touch screen is touched, the computer code comprising:
a code set for sensing one variable effecting user character input, and
a code set responsive to the sensed variable for increasing predetermined screen areas relevant to a specific information displayed.
